(19) United States
(12) Patent Application Publication
(10) Pub. No.: US 2007/0079333 A1
(43) Pub. Date: Apr. 5, 2007

(54) Information processing method using electronic guide information and apparatus thereof

(76) Inventors: Matsatoshi Murakami, Hamura-shi (JP); Hideo Kataoka, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/521,241

(22) Filed: Sep. 13, 2006

(30) Foreign Application Priority Data
Oct. 4, 2005 (JP) 2005-291428

(51) Int. Cl. H04N 7/025; H04N 5/445; G06F 3/00; G06F 13/00; H04N 7/10

(52) U.S. Cl. 725/46; 725/45; 725/34; 725/35; 725/52; 725/44

(57) ABSTRACT

To collect user preference information at a high accuracy, information processing is carried out corresponding to information such as keyword, weighting, content title and the like of user preference detected from user usage condition. At this time, the user preference is detected from one or more of the following items: reservation, recording or watching of a broadcasting program, reproduction of a recorded program, dubbing of a recorded program, reproduction of a title distributed in the form of a package software, recording of the content title, purchase of a product, and application for rental.

### CROSS-REFERENCE TO RELATED APPLICATIONS

This application is based upon and claims the benefit of priority from Japanese Patent Application No. 2005-291428, filed Oct. 4, 2005, the entire contents of which are incorporated herein by reference.

### BACKGROUND OF THE INVENTION

1. Field of the Invention

One embodiment of the invention relates to an information processing method using electronic guide information and an apparatus thereof.

2. Description of the Related Art

In recent years, digital video recorder represented by DVD has been widely prevailing instead of a conventional analog video cassette recorder. The digital video recorder can use electronic guide information such as electronic program table and electronic program guide (EPG: Electronic Program Guide or DEPG: Dynamic Electronic Program Guide) for viewing and recording programs of TV broadcasting.

By the way, the electronic guide information can be used for other purposes than indicating a broadcasting program and an example thereof is extracting preference data of a viewer such as a user.

The preference data of the user, however, is extracted based on the viewer watching a desired program without registering any keyword. More specifically, information indicating the preference of a user is obtained from data, a program guide superimposed on a watched program, or from a user operation during watching. This information is then weighted so as to indicate or recommend a program meeting a user's preference.

Since preference information is obtained from only watching and its related operation, high accuracy is not obtained. Furthermore, the preference information is used for only gathering of program recommendations or desired broadcasting data.

### BRIEF DESCRIPTION OF THE DRAWINGS

FIG. 1 is an exemplary diagram for explaining the configuration of a recording/reproducing apparatus using electronic program table according to an embodiment of the invention;

FIG. 2 is an exemplary diagram for explaining an example of a remote controller used for controlling the apparatus shown in FIG. 1;

FIG. 3 is an exemplary diagram for explaining an example of display screen of a main menu obtained according to the method of an embodiment of the invention;

FIG. 4 is an exemplary diagram for explaining an example of display of a program table which can be reached from the main menu of FIG. 3;

FIG. 5 is an exemplary diagram for explaining an example of display of a program list which can be reached form the main menu of FIG. 3;

FIG. 6 is an exemplary diagram for explaining an example of display of a software purchase screen which can be reached from the display of FIG. 4 or 5;

FIG. 7 is an exemplary diagram for explaining an example of display of a movie ticket purchase screen which can be reached from the display of FIG. 4 or 5;

FIG. 8 is an exemplary diagram for explaining an example of system configuration to which the recording/reproduction method of an embodiment of the invention is applied;

FIG. 9 is an exemplary diagram for explaining an example of action of the system configuration of FIG. 8;

FIG. 10 is an exemplary diagram showing preference information 1 indicating correspondence between the keyword and weighting;

FIG. 11 is an exemplary diagram showing preference information 2 indicating correspondence between the genre and weighting;

FIG. 12 is an exemplary diagram showing preference information 3 indicating correspondence between the price range and the keyword;

FIG. 13 is an exemplary diagram showing a program title information list;

FIG. 14 is an exemplary diagram showing a purchase product name information list;

FIG. 15 is an exemplary diagram showing the relation between user's action and corresponding processing;

FIG. 16 is an exemplary flow chart for explaining a specific example of processing;

FIG. 17 is an exemplary flow chart for explaining a specific example of processing;

FIG. 18 is an exemplary diagram for explaining an example of weighting point table to a title having the same name or a product having the same name;

FIG. 19 is an exemplary diagram for explaining an example of weighting point table to a title having the same name or a product having the same name;

FIG. 20 is an exemplary diagram for explaining an example of weighting point table to a title having the same name or a product having the same name; and

FIG. 21 is an exemplary flow chart for explaining a specific example of weighting processing of preference information.

### DETAILED DESCRIPTION OF THE PREFERRED EMBODIMENTS

An embodiment of the invention can provide an information processing method and apparatus capable of collecting user preference information at a higher accuracy than before.

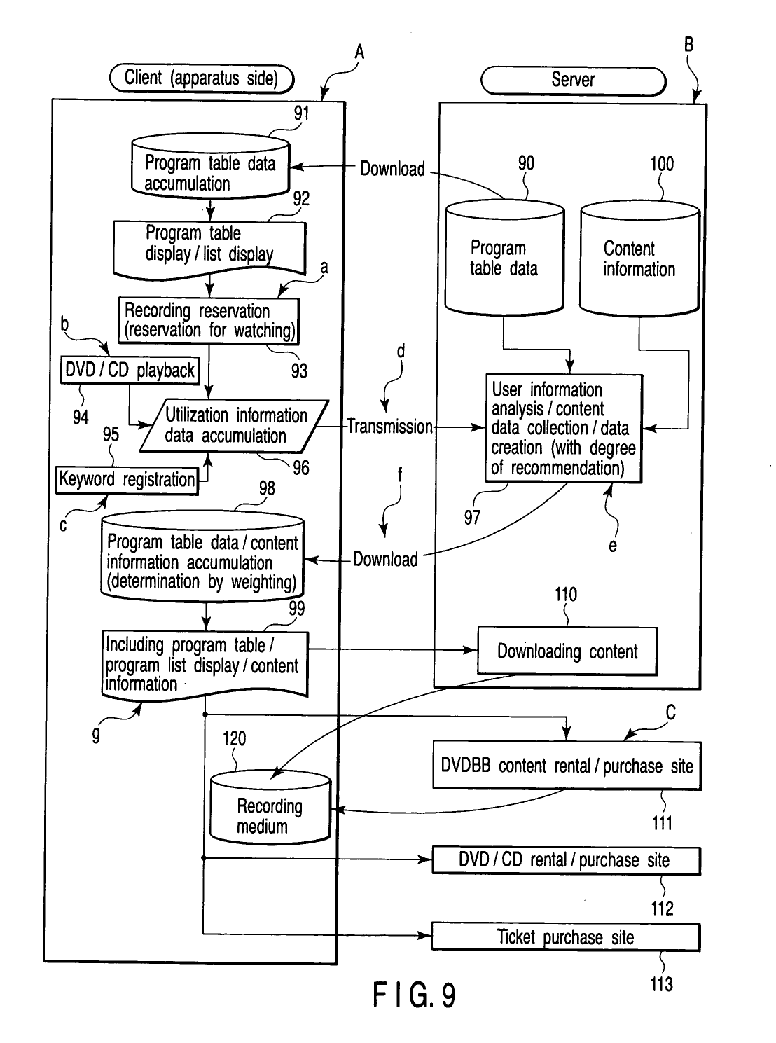

According to the information processing method of the embodiment of the invention, user's preference is detected (97) from electronic guide information obtained through broadcasting and/or communication network or user use condition (96 in FIG. 9) of distributed content title such as a title recorded in a DVD, CD or the like. Information processing (98, 99) is then carried out corresponding to information such as a keyword, weighting, content title or the like based on this detected user preference. According to this method, the user preference is detected (97) from at least one of the following items.

a) reservation on recording of the broadcasting program or on watching, reproduction of a recorded program or recording of a recorded program on an information recording medium such as DVD-R, -RW, -RAM or the like. Furthermore, content information of a recorded program can be obtained through broadcasting and/or the Internet.

b) Reproduction of the content title distributed in the style of a package software such as DVD video, sound CD and the like, or recording of this content title into information recording medium. Content information of a reproduced or recorded title can for example, be obtained through Internet database CDDB or the like.

c) Purchase of a product such as a DVD video, photo album, book or the like through a screen display of the electronic guide information. For example, person name, genre, product name and the like about the purchased product are distinguished from electronic guide information at the time of request for purchase.

d) Application for renting a product such as a DVD video or the like through a display screen of the electronic guide information.

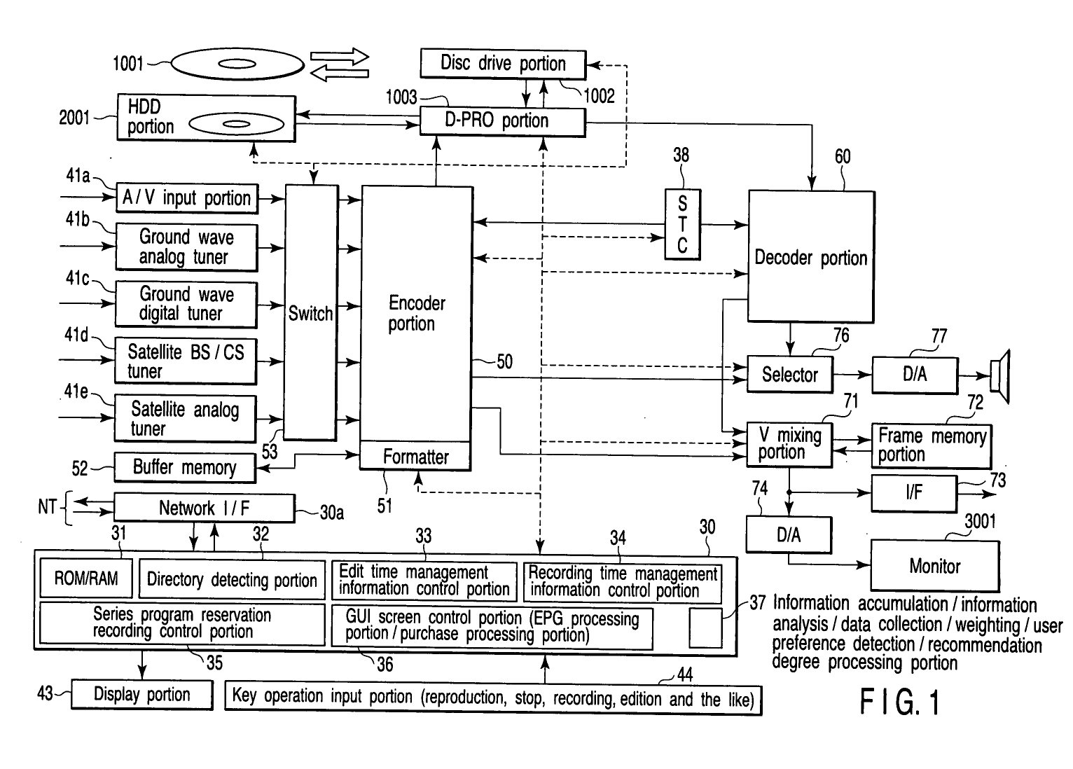

Hereinafter, the embodiments of the invention will be described with reference to the accompanying drawings. First, the outline of a recording/reproducing apparatus to which the invention is applied will be described with reference to FIG. 1. Although FIG. 1 indicates an apparatus capable of handling both optical discs such as DVD-RAM, DVD±RW, DVD±R, DVD-ROM, DVD video, CD-RW, CD-R, CD-ROM, music CD and hard disks as a recording medium or information recording medium, these hard disks and optical discs may be replaced with other recording medium such as semiconductor memory or used together.

If the configuration of FIG. 1 is largely divided, its left side indicates main blocks for recording system and the right side indicates main blocks for reproduction system. The recording/reproducing apparatus of FIG. 1 includes two kinds of disk/disc drive units, namely, a disc drive portion 1002 and a hard disk drive portion 2001. The disc drive portion 1002 drives an optical disc 1001 as a first medium in which video files can be built up to execute reading/writing of information. The disc drive portion 1002 includes a rotation control system, laser drive system and optical system for the optical disc 1001. Further, the hard disk drive portion 2001 drives a hard disk as a second medium.

A data processor portion 1003 can supply recording data to the disc drive portion 1002 and the hard disk drive portion 2001 and receive a reproduced signal. The data processor portion 1003 includes a buffer circuit, modulation/demodulation circuit, error correction circuit and the like for handling data of recording or reproducing unit.

The recording/reproducing apparatus of FIG. 1 includes an encoder portion 50 which constitutes a recording side, a decoder portion 60 which constitutes a reproducing side, and a microcomputer block 30 for controlling the operation of the apparatus main body. The encoder portion 50 includes a transport stream processing portion and a plurality of MPEG encoders.

The encoder portion 50 includes an analog/digital converter for video and audio which converts inputted analog video signal or analog audio signal to digital data, a video encoder and an audio encoder. Further, it can include an encoder for auxiliary picture which displays subtitles or picture with bitmap data appropriately.

Encode output from the encoder portion 50 is converted to predetermined DVD/RAM format with a formatter 51 containing a buffer memory. In one example, if transport stream (MPEG2-TS) of digital broadcast is stream-recorded, format conversion is not executed. The format is supplied to the data processor portion 1003. In the meantime, packet elementary stream extracted from the transport stream may be sometimes recorded in the hard disk of the hard disk drive portion 2001 directly from the encoder portion 50.

An external analog video signal and external analog audio signal can be inputted to the encoder portion 50 from an AV input portion 41a through a switch or signal selector 53. Further, a reception signal (one or plural) can be selectively inputted to the encoder portion 50 from a ground wave analog tuner 41b, a ground wave digital tuner 41c, satellite BS/CS tuner 41d or satellite analog tuner 41e.

If the encoder portion 50 contains for example, two MPEG encoders, a program received by the ground wave analog tuner 41b can be recorded in DVD-VR by the hard disk drive portion 2001 and at the same time, a program received by the satellite analog tuner 41e can be recorded in DVD-RV by the hard disk drive portion 2001 or the optical disc 1001. Even if the encoder portion 50 contains only one MPEG encoder, a program received by the ground wave digital tuner 41c(MPEG2-TS) is stream-recorded by the hard disk drive portion 2001 and at the same time, a program received by the ground wave analog tuner 41b can be watched while being recorded in DVD-VR by the hard disk drive portion 2001 or the optical disc 1001.

When compressed or encoded a digital video signal or digital audio signal is inputted directly, the encoder portion 50 can supply the compressed digital video signal or digital audio signal directly to the formatter 51. Further, the encoder portion 50 can supply digital video signal or audio signal after conversion from analog to digital directly to a video mixing portion 71 or an audio selector 76.

In the MPEG video encoder contained in the encoder portion 50, digital video signal is compressed according to variable bit rate based on MPEG2 or MPEG1 standard and converted to digital video signal to be recorded in the hard disk or optical disc. The digital audio signal is converted to digital audio signal compressed by fixed bit rate based on the MPEG or AC-3 standard or non-compressed digital audio signal based on linear PCM.

If subsidiary video signal is inputted from the AV input portion 41a for example, input of subsidiary video signal from DVD video player with independent output terminal or DVD video signal having such data configuration is broadcast and received by a TV tuner 42, the subsidiary video signal in the DVD video signal is encoded by the subsidiary video encoder such as run length encoding based on DVD standard to bitmap data of subsidiary picture.

The encoded digital video signal, digital audio signal and subsidiary picture data are packed by the formatter 51 to a video pack, audio pack or subsidiary picture pack and then, these are gathered and converted to a format (DVD-video format) specified by DVD video standard or a format (DVD-VR format) specified by DVD recording standard. The formatter 51 uses a buffer memory 52 as a work area in the above-described conversion processing.

The apparatus shown in FIG. 1 can supply information such as video, audio and subsidiary picture data packs formatted by the formatter 51 and created information to the hard disk drive portion 2001 and/or the data disc drive portion 1002 through the data processor portion 1003 and record them in the hard disk or optical disc 1001. Further, information recorded in the hard disk or optical disc 1001 can be recorded in the optical disc 1001 or the hard disk through the data processor 1003 and the disc drive portion 1002.

Edit processing such as erasing video objects of plural programs recorded in the hard disk or optical disc 1001 partly or combining objects of different programs can be carried out.

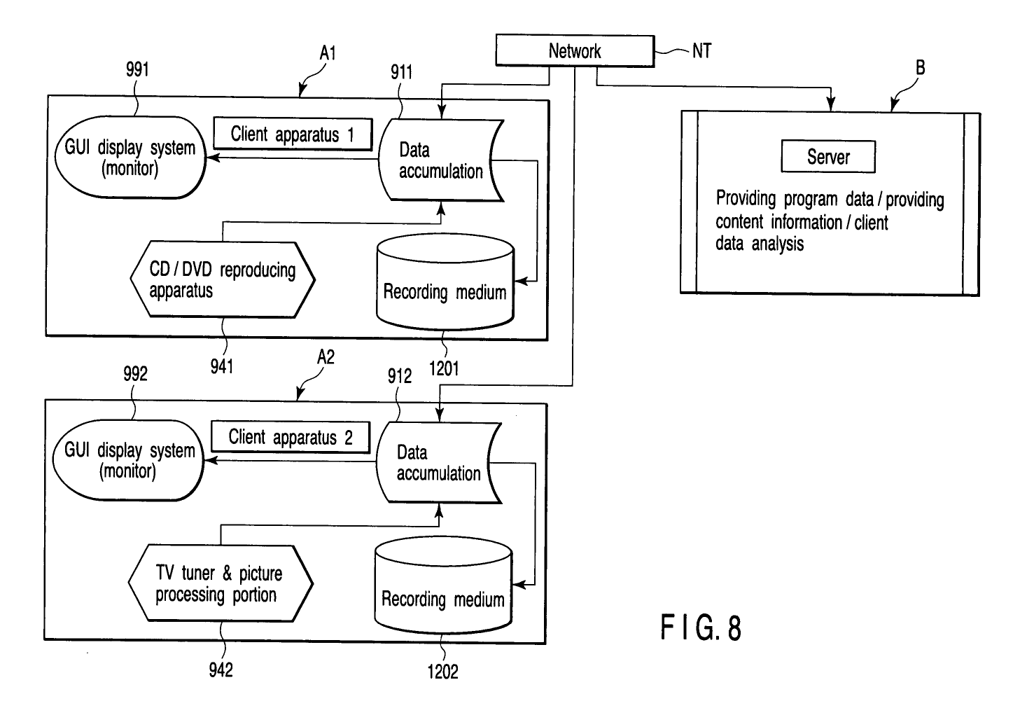

The microcomputer block 30 contains micro processing unit (MPU), central processing unit (CPU), ROM containing control program and the like, RAM for providing a work area needed for executing a program and the like. The microcomputer block 30 can fetch in information of electronic program table (a variety of information services as well as broadcasting programs) from electronic program service of ground wave analog broadcasting such as ADAMS: TV-Asahi Data and Multimedia Service in Tokyo area or electronic guide information/electronic program guide (EPG) of ground wave/satellite digital broadcasting. The microcomputer block 30 can be connected to an external network NT through a network interface 30a. Consequently, electronic program guide information can be fetched in from an external server (B in FIG. 8 or 9 described later).

The MPU of the microcomputer block 30 executes defect position detection, non-recorded area detection, recorded information recording position setting, UDF recording and AV address setting by using the RAM as a work area according to a control program or firmware stored in the ROM. The microcomputer block 30 has information processing portion for controlling respective blocks of the apparatus integrally and includes a work RAM 31, directory detecting portion 32, VMG (total video control information) information creating portion, copy related information detecting portion, copy & scrambling information processing portion such as an RDI processing portion, packet header processing portion, sequence header processing portion, aspect ratio information processing portion and the like. Further, the microcomputer block 30 includes a control portion 34 for control information for use in executing recording of pictures and a control portion 33 for control information for use in executing edition.

The microcomputer block 30 further comprises a series program reservation/recording control portion 35 and GUI (graphic user interface) screen control portion 36. The operations of the series program reservation/recording control portion 35 and the GUI screen control portion including for example, EPG processing portion, purchase processing portion and the like will be described later.

Among execution results of the MPU of the microcomputer block 30, the content which should be notified to user is displayed on a display portion 43 of the picture data recording/reproducing apparatus or on the OSD (on-screen display) of the monitor display 3001.

The microcomputer block 30 includes a key input portion 44 for giving a control signal for operation of the apparatus. This key input portion 44 corresponds to operation switches provided on the main body of the recording/reproducing apparatus or a remote controller. A personal computer connected to the recording/reproducing apparatus through wired communication, radio communication, optical communication or infrared communication can be used for the operation of the apparatus shown in FIG. 1. According to any embodiment, recording processing of picture sound signal received or inputted, reproduction processing of a recorded content or an optical disc or edit processing to a recorded content can be executed by user's operating this key input portion 44.

Timing for the microcomputer block 30 to control the disc drive portion 1002, the hard disk drive portion 2001, the data processor portion 1003, the encoder portion 50 and/or the decoder portion 60 can be executed based on time data from the STC (system time clock) 38. Although ordinarily, the operation of recording or reproduction is executed synchronously with the time clock from the STC 38, other processing may be executed at an independent timing of the STC38.

Although not shown, the decoder portion 60 comprises a separator for separating each pack from a signal of the DVD format having a pack configuration and taking it out, a memory used for separating packs and executing other signal processing, a V decoder for decoding main picture data (content of video pack) separated by the separator, a subsidiary picture decoder for decoding subsidiary picture data (content of subsidiary picture pack) separated by the separator, and an A decoder for decoding audio data (content of audio pack) separated by the separator. The decoder portion 60 includes a video processor which synthesizes a decoded main picture with a decoded subsidiary picture appropriately and outputs with a menu, highlight button, subtitles and other subsidiary picture superimposed thereon.

An output video signal of the decoder portion 60 is inputted to the video mixing portion 71. The video mixing portion 71 synthesizes for example, text data. Lines for fetching in a signal directly from TV tuner or AV input portion 41a are connected to this video mixing portion 71. A frame memory 72 for use as a buffer is connected to the video mixing portion 71. If an output of the video mixing portion 71 is analog output, it is outputted to outside through an interface (I/F) 73 and if it is digital output, it is outputted to outside through a digital/analog converter 74.

An output audio signal of the decoder portion 60 is converted by a digital/analog converter 77 through a selector 76 and outputted to outside. The selector 76 is controlled according to a select signal from the microcomputer block 30. As a consequence, when the selector 76 directly monitors a digital signal from the TV tuners 41b-41e or AV input portion 41a, it can directly select a signal passing through the encoder portion 50.

In the meantime, the formatter 51 of the encoder portion 50 creates each demarcation information and sends it to the MPU of the microcomputer block 30 periodically during recording (information at the time of interruption to GOP head). The demarcation information includes the quantity of packs of VOBU, end address of I picture from the head of VOBU, reproduction time of VOBU and the like.

At the same time, information from the aspect information processing portion is sent to the MPU when recording is started and the MPU creates VOB stream information (STI). Here, the STI stores resolution data and aspect data and at the time of reproduction, each decoder portion carries out initial setting based on this information.

The quantity of video files to be recorded in the DVD is a file per a disc. Further, to continue reproduction without an interruption during access (seek) to data, the minimum information unit (size) which continues is determined. This unit is called contiguous data area (CDA). The CDA size is a multiple of error correction code (ECC) block (16 sectors) and the file system records in this CDA unit.

The data processor portion 1003 receives data of VOBU unit from the formatter of the encoder portion 50 and supplies data of CDA unit to the disc drive portion 1002 or the hard disk drive portion 2001. When the MPU of the microcomputer block 30 creates control information used for reproducing recorded data and recognizes a command indicating data recording termination, it sends the created control information to the data processor portion 1003. As a consequence, the control information is recorded in the disk/disc. Thus, when encoding is being carried out, the MPU of the microcomputer block 30 receives information such as demarcation information of data unit from the encoder portion 50. Further, the MPU of the microcomputer block 30 recognizes control information (file system) read out from an optical disc and hard disk at the time of recording start, recognizes a non-recorded area of each disk/disc and sets up a recording area on data in a disk/disc through the data processor portion 1003.

The apparatus of FIG. 1 includes means (36) for processing to display electronic guide information obtained through broadcasting and/or communication line, means (50-51, 1001-1003, 2001) for processing to record a broadcasting program or other program corresponding to the electronic guide information and means (37) for detecting user preference from the electronic guide information or user usage condition of a distributed content title and executing information processing corresponding to information of this detected user preference. The user preference is detected from one or more of the following items.

a) Reservation on recording of the broadcasting program or on watching, reproduction of a recorded program or recording of a recorded program on an information recording medium.

b) Reproduction of the content title distributed in the style of a package software, recording of this content title into information recording medium.

c) Purchase of product through a display screen of the electronic guide information such as person name, genre, product name and the like about the purchased product are distinguished from electronic guide information at the time of application for purchase.

d) Application for renting a product through a display screen of the electronic guide information.

The picture receiving apparatus such as a digital TV containing the major portions of the apparatus of FIG. 1 includes means (36) for processing to display electronic guide information obtained through broadcasting and/or communication line, tuners (41b-41e) for receiving broadcasting, a monitor (3001) for displaying picture of information processed by the means (36) and/or picture of broadcasting received by the tuners, and means (37) for detecting user preference from user usage condition of the electronic guide information and executing information processing corresponding to information such as keyword, weighting and the like of this detected user preference. The user preference is detected from at least one of the following items.

a) User's reservation on watching of the broadcasting program using the electronic guide information.

b) Purchase of product through a display screen of the electronic guide information such as person name, genre, product name and the like about the purchased product are distinguished from electronic guide information at the time of application for purchase.

c) Application for renting a product through a display screen of the electronic guide information.

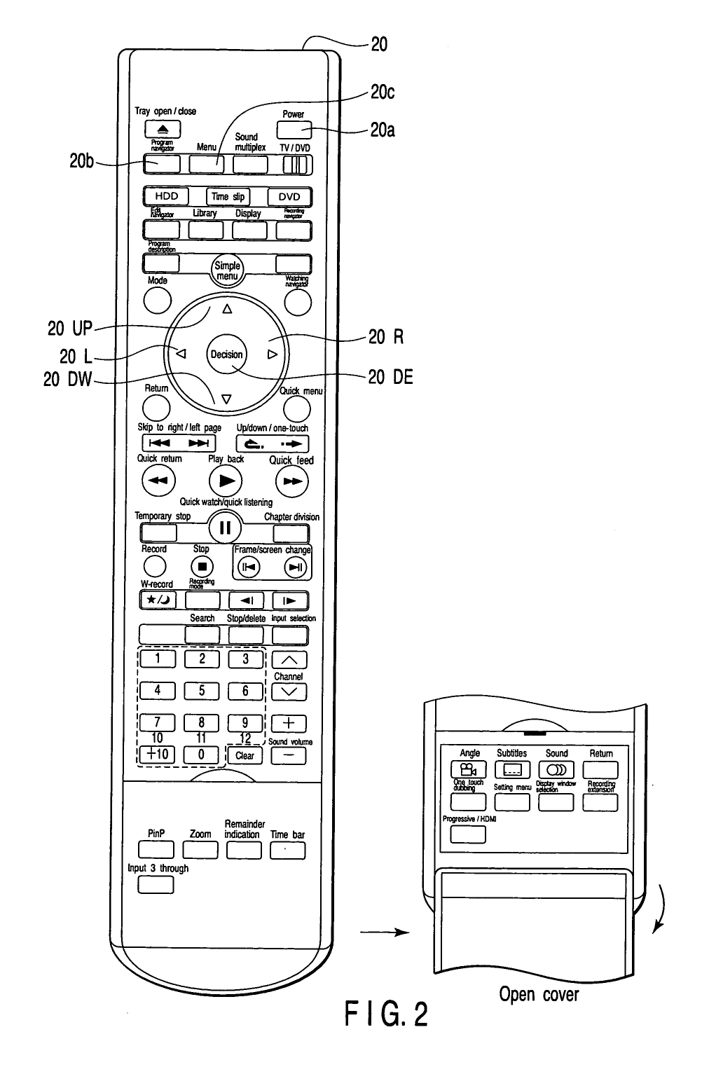

FIG. 2 shows a view of a remote controller 20. Its main control keys will be described. Reference numeral 20a denotes a power key for turning ON/OFF power and reference numeral 20bdenotes a program navigation key for starting program navigation (20b may be used as top menu key for displaying top menu screen). A menu key 20c is a control key for displaying a menu recorded in such a medium as DVD. Reference numeral 20DE denotes a decision key and reference numerals 20UP, 20DW, 20R, 20L denote cursor control keys for moving the cursor up/down and to the right/left.

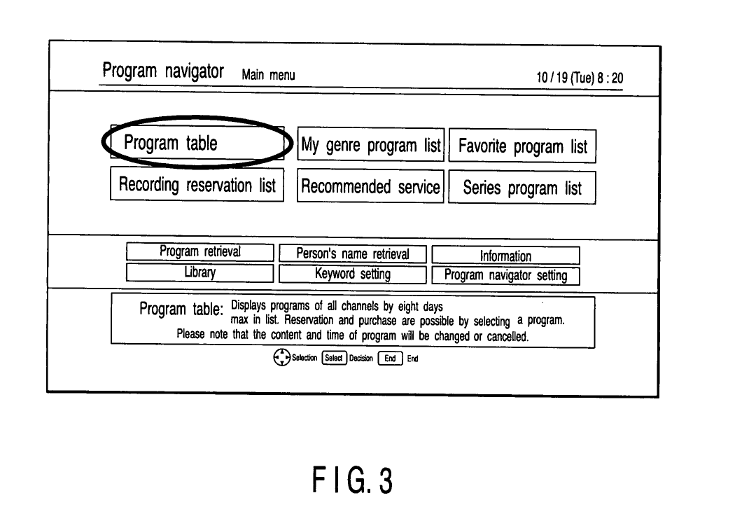

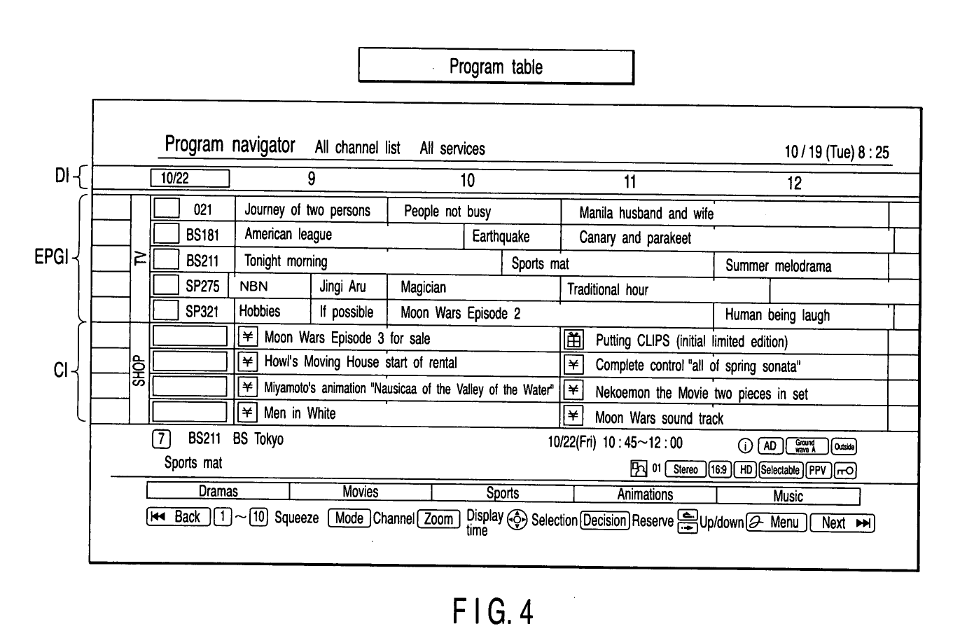

Next, characteristic structure and action of an operation using the electronic program table (electronic guide information) in the apparatus of FIG. 1 will be described. When the program navigation key (top menu key) 20b is operated, the main menu (guide screen) shown in FIG. 3 is displayed on the monitor 3001 under a control of the screen control portion 36. The main menu of FIG. 3 displays “program table”, “recording reservation list”, “My genre program list”, “recommended service”, “favorite program list”, “series program list” and the like. If the cursor key of the remote controller 20 is operated in the main menu of FIG. 3, and for example, “program table” is selected and the decisive key 20DE is pressed, the screen as shown in FIG. 4 is displayed.

FIG. 4 is a diagram for explaining an example of display of the program table which can be reached from the main menu of FIG. 3. The program table screen of FIG. 4 displays information EPGI of an electronic program table obtained through broadcasting and/or communication line, date information DI corresponding to its display content, content information CI which can be prepared corresponding to user usage condition of this program table and the like. In this display example, TV broadcasting programs (corresponding to EPGI) of five stations are exemplified in a broadcasting time (corresponding to DI) from 9:00 AM to 12:00 of Oct. 22, 2005 and advertisement (corresponding to CI) of related selling product/rental product is displayed on the same screen.

User intends to record an old movie “Moon Wars Episode 2” expected to be broadcasted from 10:00, October 22 when he sees this screen. Since an advertisement on DVD of a subsequent movie “Moon Wars Episode 3” is displayed on the same screen and thus, he may feel like purchasing that DVD video disc. Then, he can apply for the purchase of the same DVD at Internet shop through the same screen or purchase the same DVD at a video shop in the neighborhood. Additionally, he is attracted by an advertisement about rental startup of another topic movie “Howl's Moving House” and consequently, it can be expected that he feels like watching that rental software.

In this case, a content provider, product retailer and the like preliminarily informed of what program is to be broadcasted by which station on a period of time from 9:00 to 12:00 of Oct. 22, 2005 can ask the creator of electronic program table such as the company related to advertisement company to display, as part of content information CI, advertisement of other product and/or software, video/music program which can attract users interested in a program broadcasted on that period of time on the same program table screen. Consequently, more efficient advertisement providing a higher effect becomes possible than broadcasting commercial picture repeatedly at random in a concept that he that shoots oft at last shall hit the mark.

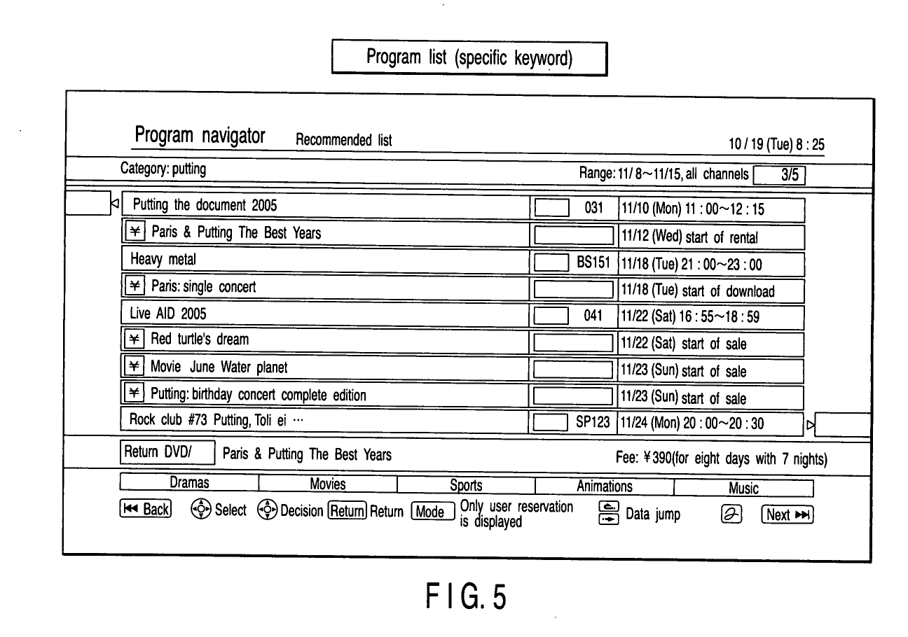

FIG. 5 is a diagram for explaining an example of display of program list which can be reached from the main menu of FIG. 3. This diagram exemplifies a program list (recommended list related to Putting) which is obtained when for example, a rock singer “Putting” is entered as a specific keyword in setting of a keyword for the main menu. Here, recommended programs and advertisements obtained with “Putting” as the specific keyword are exemplified. That is, “Putting the Document 2005” is displayed as a document program in which Putting plays with a broadcast station and broadcasting time period and an advertisement about “The Best Years” including hit music of “Paris”, a legendary rock group for which Putting played as its leader and Putting himself is displayed with date of its DVD software rental startup and rental fee.

Additionally, an advertisement on “Single Concert”, a concert video by “Paris” is displayed in this recommendation list with date of startup of charged download of its DVD software and an advertisement on “Birthday Concert” performed by PUTIIGN after the Paris was broken up is displayed with a date of startup of its DVD software. If user wants to see for example, “The Best Years by the Paris and Putting”, he can apply for its rental through the screen of FIG. 5 or visit a rental shop in the neighborhood on the rental startup day an example of business model according to an embodiment of the invention.

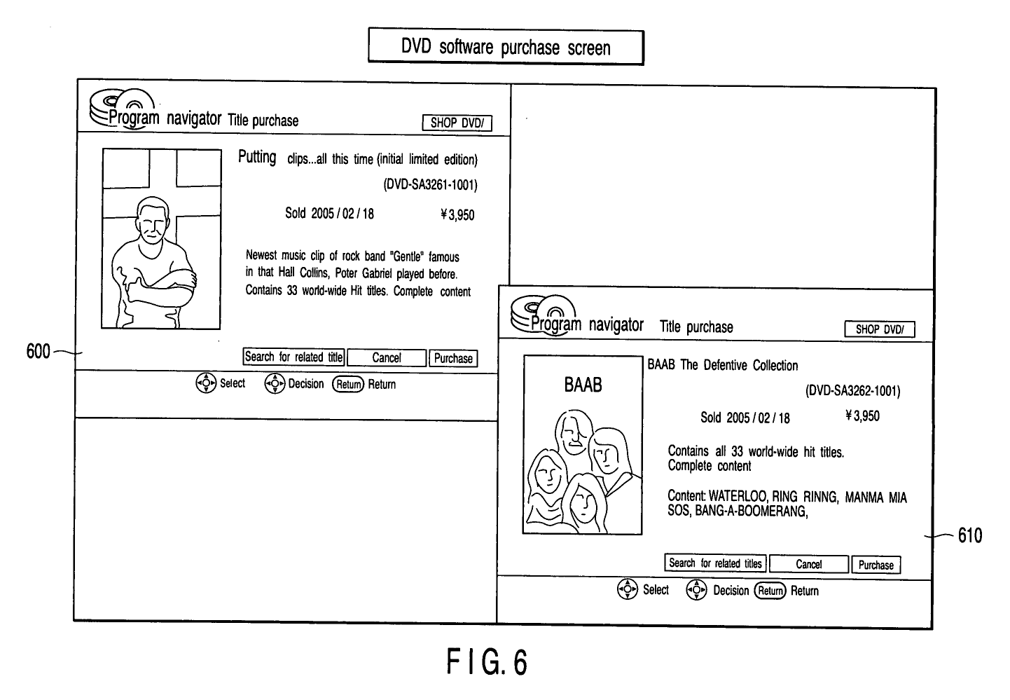

FIG. 6 is a diagram for explaining an example of a display of a software purchase screen which can be reached from the display of FIG. 4 or FIG. 5. For example, if the program navigator such as total service screen of electronic program list of FIG. 4 or a recommended list of FIG. 5, contains a DVD sales advertisement of “Putting” video clip, move the cursor to that advertisement portion by operating the remote controller of FIG. 2 and push the decision button, and thereby the Putting purchase guide screen 600 of FIG. 6 is displayed. Further, if a certain program navigator contains a DVD sales advertisement of music video of “BAAB”, move the cursor to that advertisement portion by operating the remote controller and push the decision button, and thereby the BAAB purchase guide screen 610 of FIG. 6 is displayed.

If user wants to know other title information of “Putting” or “BAAB”, he can retrieve the related titles by operating the remote controller to display them. If user wants to purchase the DVD of a displayed title, he selects its purchase icon from the Putting purchase guide screen 600 of FIG. 6 by operating the remote controller and pushes the decision button. As a result, a DVD of “Putting” video clip can be sent to that user through home delivery service by collect from the distributor in another example of business model according to an embodiment of the invention.

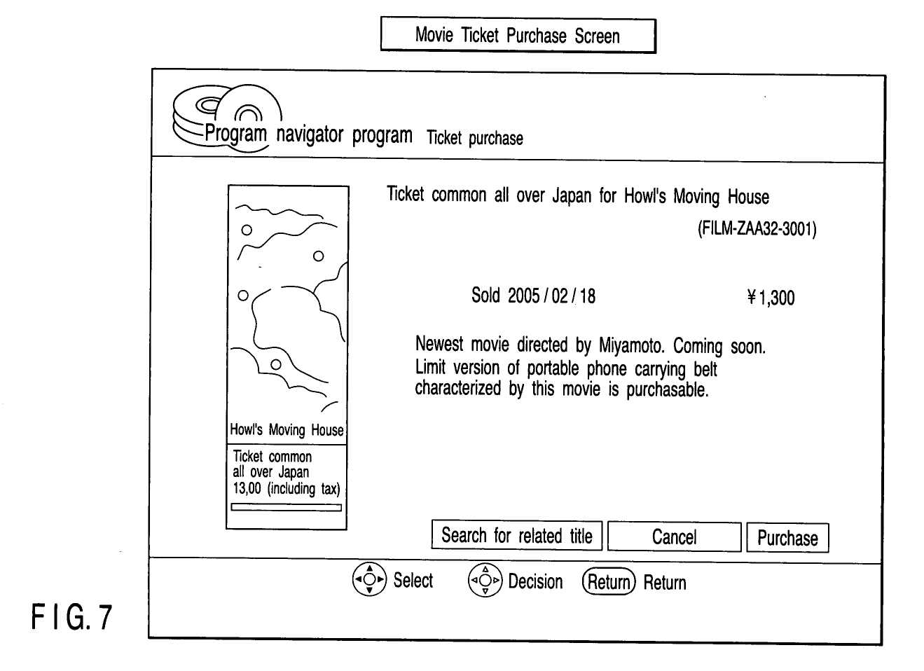

FIG. 7 is a diagram for explaining an example of the display of a movie ticket purchase screen which can be reached from FIG. 4 or an indication in FIG. 4. For example, if user who comes to know “Howl's Moving House” from an advertisement of the program navigator of FIG. 4 wants to see it at a theater rather than watching with a home video such as after retrieval for a theater which shows that movie, he can purchase a movie ticket through a screen which he sees now still another example of business model according to an embodiment of the invention.

FIG. 8 is a diagram for explaining an example of system configuration to which the recording/reproducing method of an embodiment of the invention is applied. In this system, a first client apparatus (DVD recorder or the like) A1 and/or a second client apparatus (digital TV or the like) A2 is connected appropriately to a server B through network, for example, Internet. The server B provides a program list (EPG), content information (CI) and analyzes client data. The client apparatus A1 includes a data accumulating portion (database) 911 which accumulates information about actions of the apparatus (action of CD/DVD reproducing apparatus 941, recording into recording medium 1201 such as HDD or DVD-R/RW/RAM, user's operation through display on GUI display system (monitor) 991 and the like) and information from the server B. Further, the client apparatus A2 includes a data accumulating portion (database) 912 which accumulates information about actions of the apparatus (action of TV tuner and a picture processing portion 942, recording into recording medium 1202 such as HDD, DVD-R/RW/RAM, user's operation through a display on the GUI display system (monitor) 992) and information from the server B. [0081] The client apparatus (A1/A2) is constructed to have following functions in the system configuration of FIG. 8:
Function of displaying contents other than broadcasting and service information integrally, and program table, program list, program retrieval and display interface;
Function of specifying whether or not a specific content is to be displayed, display order, quantity of displayed information, content to be displayed by user's setting or setting on the server (server setting can be done by user);
Having database for accumulating user's preference;
Function of recording reservation, execution of reservation, execution of reproduction of recorded content, erasing of recorded content, storage of the recorded content in a portable medium (DVD-R/RW/RAM and the like), control of library (metadata) information, playback of portable medium such as CD/DVD, accumulation of purchase history information about contents and service, retrieval of information and automatic retrieval keyword and/or transmission to server (accumulation/registration of user's system usage condition and library information and the like can be carried out by the data accumulation 96 in FIG. 9 described later.); and
Function of automatically or manually acquiring, from the server, information recommended (by content provider or sales agent) and/or information needed by users.

In the system configuration shown in FIG. 8, its server side (B) is constructed to have following functions:
Function of specifying a client;
Function of accumulating client information;
Function of accumulating and transmitting program data for program table system;
Function of collecting and accumulating various content data other than program data;
Function of analyzing and relating accumulated client information and various content information, providing with a degree of recommendation, distributing to a client;
Function of corresponding to content purchase and application for rental from client; and
Function as an accounting system.

FIG. 9 is a diagram for explaining an example of operation (example of operation procedure) of the system configuration of FIG. 8.

1. Client apparatus (A1/A2) side:
Acquires and accumulates program table data from the server B side (91) and accumulates recording reservation information which can specify a program based on unique channel code and date information from that program table data (91-93, 96). The accumulated data is sent to the server periodically (d);
Accumulates metadata (information acquired using data service such as CDDB) of marketed software such as DVD and CD used by user (94, 96);
Accumulates automatic retrieval keyword specified by user (95, 96);
Transmits the above-mentioned usage information to the server continuously and periodically (d); and
Transmits attached information such as apparatus usage area, sex, age, generation, blood type, star sign and the like to the server (d).

2. Server (B) side:
Specifies a client from apparatus information and attached information;
Specifies user's preference based on updated recording reservation information, keyword, metadata of DVD and CD (97) from client; and
Extracts content information from content information collected by server and content information such as DVDBB according to preference specified by client. Further, the content information is weighted such as provided with degree of recommendation depending on the preference specified by client. Content information CI is transmitted to a client apparatus A as one of program table information which specifies time period and display area depending on the usage frequency and recording frequency of client (f).

3. Integrated user interface (UI) by program table/program list interface on the side of client apparatus (A1/A2):
Displays transmitted program information that includes content information CI. At this time, content and service information are displayed in the form of the program table and program list depending on total indication, genre, content type, particular keyword, particular theme (99);
A variety of factors can be displayed in list or by squeezing such that they are inserted in an ordinary program table (see FIG. 5);
Displays a variety of elements in cycle;
Provides a direct link from the displayed various elements and jumps to plural item list of program list style;
Selects display mode with a single button; and
Enables rental, purchase and downloading to be executed by selecting content information (see FIGS. 6, 7).

An example of specific operation of the system configuration of FIG. 8 will be described with reference to FIG. 9:
Client's (user's) downloading (91) of program data (90);
Client's recording (93) TV broadcasting in which “Mika NAKASHIMA” appears from program list (92)→storing data (96);
Client's reproducing “Mika NAKASHIMA” from CD for watching (94)→acquiring data from CDDB→storing data (96);
Client's registering “Mika NAKASHIMA” as keyword (95)→storing data (96);
Transmitting accumulated data (96) to server (d);
Analysis of client preference by server (97) to extract “Mika NAKASHIMA”;
Collecting information about “Mika NAKASHIMA” from content information and provided it with a degree of recommendation (97):
“Mika NAKASHIMA” concert ticket on sale: high degree of recommendation
Purchase of “Mika NAKASHIMA” live DVD: medium degree of recommendation;
Information on “Mika NAKASHIMA” new album: low degree of recommendation;
Transmitting content information to client (f);
Going to a specified area corresponding to the degree of recommendation in client's program list;
Displayed in order of “Mika NAKASHIMA” concert ticket on sale→purchase of “Mika NAKASHIMA” live DVD→information on “Mika NAKASHIMA” new album (98, 99); and
When client selects “live DVD” by remote controller operation and pushes a decision button of the remote controller, the screen changes to a purchase screen (see FIGS. 6, 7). User can purchase a desired software product such as downloading a charged software, purchasing a desired disc or purchasing a desired ticket and the like or apply for rental (111-113; 110, 120).

In the meantime, it is permissible to adopt a processing which enables KARAOKE to be purchased by a music piece such as the data as in KARAOKE box by attaching a mike terminal or the like to the client side as purchase processing here.

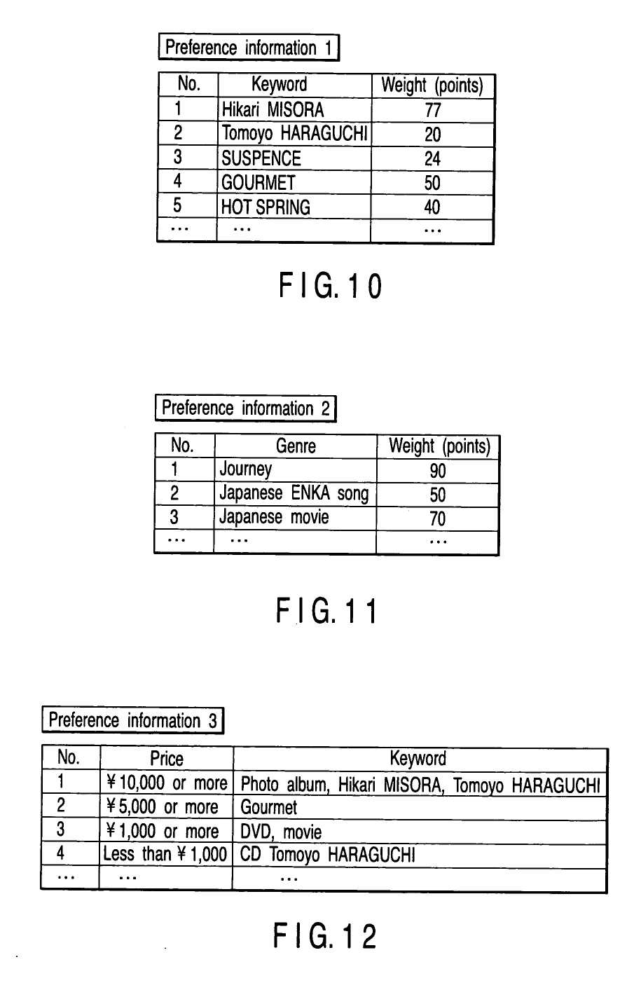

FIG. 10 is a diagram exemplifying preference information 1 which indicates correspondence between keyword and weighting. Here, a relation between a keyword such as keywords classified according to singer, player, genre and the like having a relatively high frequency of user's recording or watching (user usage condition) and the number of points of weighting corresponding to usage condition (frequency) is exemplified. The keyword registration can be executed by processing 95 in FIG. 9 and the correspondence (preference information 1) of FIG. 10 can be stored by processing 96 of FIG. 9 (its content is updated and accumulated as user's usage progresses).

For example, even if the weight (degree of interest of user) of Hikari MISORA is low (or even if there is no registration in FIG. 10), the correspondence of FIG. 10 (preference information 1) is updated when the user has interest in Hikari MISORA and reserves on recording of broadcasting of Hikari MISORA frequently or purchases a CD of Hikari MISORA through Internet, so that the weighting of Hikari MISORA in newest condition may reach a highest point. A keyword having the highest weight can be used as a specific keyword (corresponding to PUTIING in the example of FIG. 5) which is a first recommendation to user.

FIG. 11 is a diagram exemplifying preference information 2 which indicates correspondence between the genre and weighting. In case of user who records or watches programs belong to genre “travel” most frequently although performers of the programs vary, the weighting of the genre of “travel” is a highest point. The correspondence (preference information 2) of FIG. 11 can be stored by processing 96 of FIG. 9 (its content is updated and accumulated as user's usage progresses).

FIG. 12 is a diagram exemplifying preference information 3 indicating correspondence between price range and keyword. In this example, a related keyword for example, photo album of Hikari MISORA) is set up for each specific keyword. For example, MIRORA HIKARI) and its price range, for example, more than 10,000 yen is related to that keyword (photo album of Hikari MISORA).

Preference information 3 has a content which gathers products who user may purchase through an advertisement by recommendation despite a slightly expensive price because they are related to a singer such as having the highest point of weighting in preference information 1 of FIG. 10, whom the user is estimated to have the highest interest at currently. The preference information 3 having such content can be created by a content provider or advertisement company using market research result or the like. The correspondence (preference information 3) of FIG. 12 can be stored in the database of the processing 100 of FIG. 9 such as the content is changed appropriately corresponding to market trend or change in fashion.

The above-described preference information 1—preference information 3 can be used in an appropriate combination. For example, if preference information 1 and preference information 3 are transmitted from the client side processing 96 to the server side processing 97 in FIG. 9, the server side B extracts products of Hikari MISORA such as DVD video, music CD, programs scheduled to be broadcast and the like in which user is estimated to be interested currently from the content information 100 and/or database of the program table data 90, lists them according to their prices such as product and/or program having a higher degree of recommendation is ranked with a higher No. and returns the result to the client A side.

The returned recommended product/program list is presented to user by the processing 99 of FIG. 9. If user wants to purchase for example, Hikari MISORA's premium box, he can access to the rental/purchase site 112 of DVD/CD on Internet and purchase that DVD. For example, in processing at the time of purchase, a product ID of FIG. 14 is specified. “Such a processing by referring to the degree of recommendation based on an interest of individual user at each point of time” enables much more effective advertisement, which may result in increase of sale of the product than making advertisement at random which is an example of business model according to an embodiment of the invention.

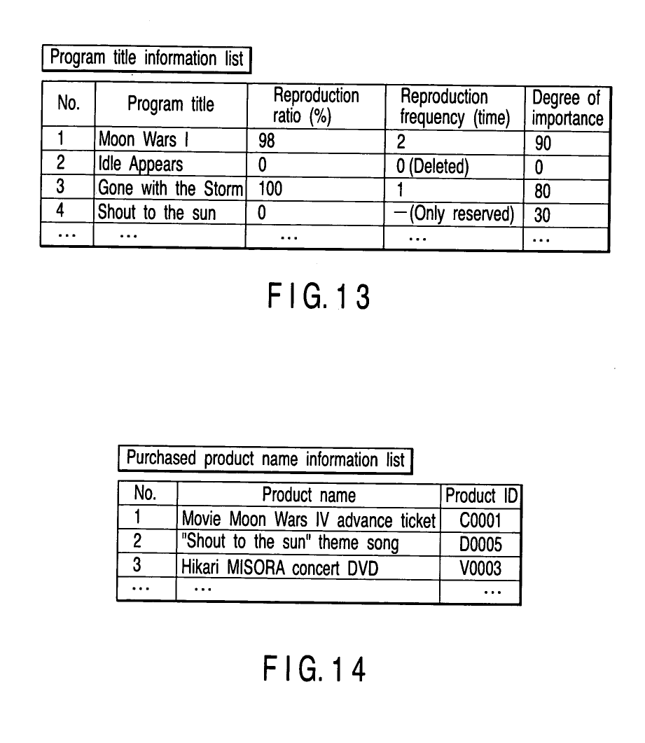

FIG. 13 is a diagram exemplifying program title information list. This example provides the degree of importance of a given title to user with a number of points, based on plural parameters such as reproduction ratio such as what percentage of the give title is reproduced by that user and reproduction frequency such as how many times it is reproduced.

For example, a recorded tile (“Gone with the Storm”) which is reproduced once although it is reproduced 100% from its beginning to its end is supplied with a degree of importance of 80 points. A recorded title (“Moon Wars 1”) which for example is reproduced 98% of all (reproduction in which user watched all main portion although he did not see a telop about performers presented after the main portion of the movie ends) although not 100% while the reproduction is repeated twice (plural times) is supplied with a degree of importance of 90 points.

In case of a title recorded with a recorder based on for example, DVD-VR DVD video recording standard, the above-mentioned reproduction ratio of percentage value can be calculated from reproduction resume information such as reproduction time at last reproduction interruption point stored in management information and the recording time of an entire title.

On the other hand, the degree of importance of a title (Shout to the sun) which has not been watched (reproduction ratio of 0%) although it is recorded by reservation on recording is set to 30 points and a title (Idle appears) which is erased without being watched (reproduction ratio of 0%) by user although it is recorded is set to 0 point. A list of FIG. 13 is accumulated by processing 96 of FIG. 9 (the content is updated and accumulated as user's usage progresses).

Although supplying the degree of importance with a number of points is executed based on the reproduction ratio and reproduction frequency in the example of FIG. 13, when an algorithm of supplying with a number of points actually is determined, the age, sex, address area, date of supplying with the number of points, and other factors such as market research result can be referred to. For example, if user is a man aged 10-20 years old living in Tokyo where a number of movie theaters having latest facility exits and the current time is a time just before “Moon Wars Episode 2” is publicized, it is possible to adopt an algorithm which provides the degree of importance with a higher number of points (or larger weight) than a different program title whose reproduction ratio and reproduction frequency are equal (in this example, if user watches broadcasting or recorded picture of Moon Wars Episode 1, a possibility that the user may purchase a ticket of Moon Wars Episode 2 which is advertised at that time, is high).

FIG. 14 is a diagram exemplifying purchase product information list. This example supplies each product related to the keywords in FIG. 12 or program title of FIG. 13 with an identifier which specifies that product (product ID suitable for electronic processing). That is, a product group related to the keyword can be specified with ID code. The list of FIG. 14 can be accumulated by processing 100 of FIG. 9 (a listed product is changed appropriately corresponding to a market trend).

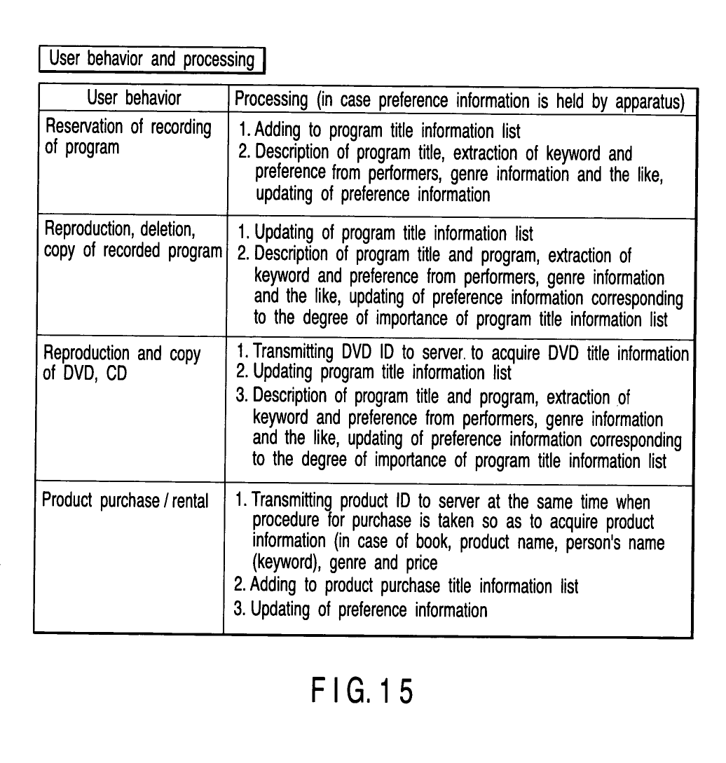

FIG. 15 is a diagram exemplifying the relation between user's behavior and corresponding processing. This table exemplifies which processing is carried out on a client apparatus side corresponding to a behavior of each user.

That is, if the behavior of user is “reservation on recording of a program”, the processing in case of holding preference information on the client apparatus side can include: adding to program title information list (FIG. 13); and description of program title and program, extraction of keyword and preference from performers, genre information and the like, updating of preference information.

If the behavior of user is “reproduction/erase or copy of recorded program”, the processing in case of holding preference information on the apparatus side can include: updating of program title information list (FIG. 13); and description of program title and program, extraction of keyword and preference from performers, genre information and the like, updating of preference information corresponding to the degree of importance of program title information list.

If the behavior of user is “reproduction of DVD or CD or copy”, the processing of holding preference information on the side of client apparatus includes: transmitting DVD ID to server so as to acquire title information of the DVD; updating of program title information list (FIG. 13); and description of program title and program, extraction of keyword and preference from performers, genre information and the like, updating of preference information corresponding to the degree of importance of the program title information list.

If the behavior of user is “purchase of product/rental”, the processing of holding preference information on the client apparatus side includes: sending product ID to server at the same time as procedure for purchase so as to acquire product information (for a book, product name, person name (keyword), genre, price); adding to product purchase title information list (FIG. 14); and updating of preference information.

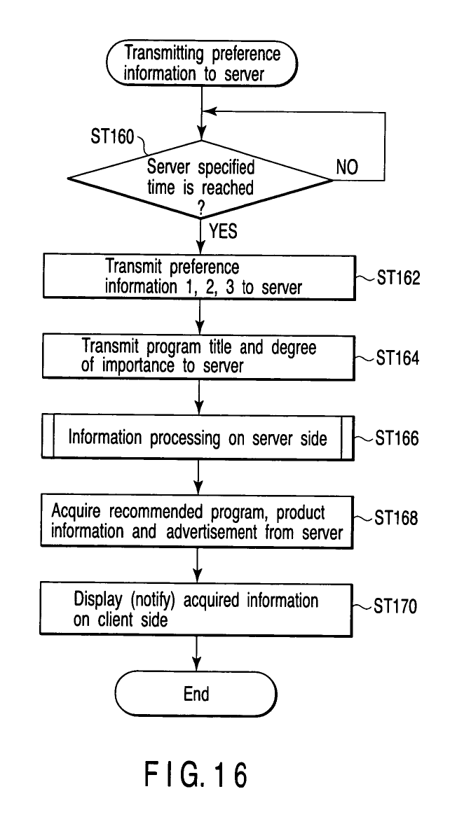

FIG. 16 is a diagram of a flow chart for explaining a specific example of the processing. If time for sending preference information to the sever is predetermined (four times, 0:00, 6:00, 12:00, 18:00 every day), the client apparatus A of FIG. 9 sends preference information 1-3 (FIGS. 10-12) to the server B when that time is reached (Yes in block ST160, block ST162). Further, the client apparatus A sends information about program title and its degree of importance to the client apparatus A (block ST164).

The server carries out a processing of extracting a product estimated to provide the highest advertisement effect upon user from received information (indicating an interest of user of a client apparatus which sends that information at a current time) (block ST166). A purchase product name information list (example of FIG. 14), in which the advance ticket of a new theater type movie “Moon Wars 4” is listed up first for the user for whom the degree of importance of a program title named “Moon Wars 1” is the highest (example of FIG. 13), is treated by processing 97 on the sever side. In block ST166, information (content of FIG. 5) of a recommended program which looks most interesting to that user (possibly leading to high audience rate) can be extracted from the received information.

The information obtained in this way (information about recommended broadcasting, recommended product, recommended advertisement and the like) is sent from the server to the side of a client apparatus (block ST168). Then, information sent to the user (recommended program, recommended product, recommended advertisement and the like) is displayed on the client apparatus and notified (block ST170 . . . corresponding to processing 99 of FIG. 9).

The reason why notification is exemplified in addition to display is that there is a possibility that user does not notice recommended product information just on a screen display because he concentrates on creation of document on a personal computer. In such a case, if it is so constructed that existence of product information can be notified through audio guide or the like, user can know the recommended product information (for example, release information of limited edition DVD of his favorite singer)

Although block ST160 of FIG. 16 makes a determination so as to send preference information periodically, another determination may be carried out. For example, it can be so constructed that a time for sending preference information to the server is not determined and its updated preference information is sent from the client apparatus A to the server B in real time if the preference information of FIGS. 10-13 is updated in any way (Yes in block ST160).

Alternatively, in spring, autumn and end of year in which publications of new product are concentrated, it is permissible to set a transmission time of preference information to after a termination of broadcasting of a program in a specific time range (18:00-22:00) without specifying the transmission time of preference information to the server (Yes in block ST160: the broadcasting termination time is not limited to scheduled but may be nonscheduled) or increase the frequency of transmission of preference information of each day.

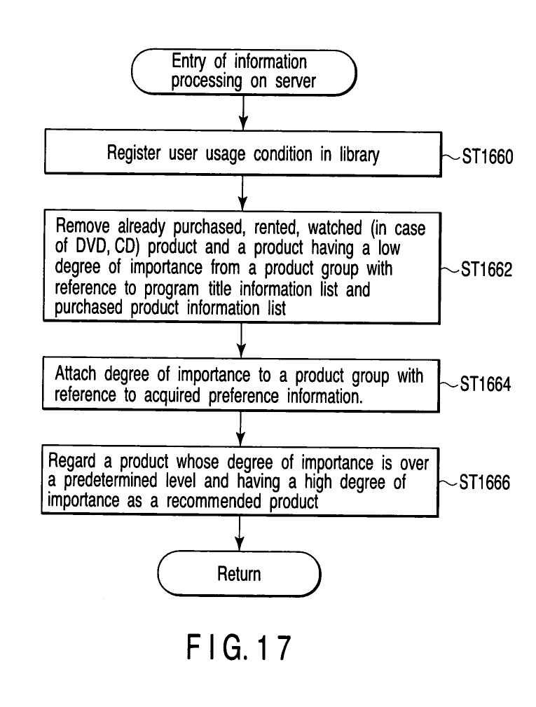

FIG. 17 is a flow chart for explaining a specific example of information processing on server side in FIG. 16. Accumulation and registration of system utilization condition by user and library information accompanied by this system utilization (purchase of product and application for rental by a given user) can be carried out by data accumulation 96 in FIG. 9. This library information is registered in library by processing 97 on the server side (block ST1660). This library enables a product (DVD and CD) already purchased by the given user to be known and/or a software (title) already rented/watched by the given user to be known. Other user information (information relating to FIGS. 10-15) is transmitted to the processing 97 on the server side.

In the processing 97 on the server side of FIG. 9, already purchased products, rented/watched product (DVD/CD) and products having a low degree of importance are excluded from a given product group (including broadcasting programs appropriately) with reference to the program title information list (FIG.13) and the purchase product name information list (FIG. 14) (block ST1662). The processing 97 on the sever side supplies the product group with a degree of importance with reference to acquired preference information (block ST1664). Then, a product whose degree of importance is higher than a predetermined value is listed up as a recommended product (or a recommended program) and returned to the side of client apparatus (block ST1666).

Since this processing (block ST1666) is provided with a condition that the degree of importance is over a predetermined value, a product having a low advertisement effect upon individual user and/or a product which may not lead to a rise of audience rate can be set not to be listed up as a recommended product/recommended program to user (since a recommendable product or program becomes likely to be neglected if the quantity of information to be listed up increases, a processing of not listing up non-recommendable product/program is indispensable).

For example, assume a DVD video disc (or CD disc of music product) of a certain movie as a recommendable product. Information of watch/purchase history of whether or not this disc is watched by user and/or this disc is purchased is registered in library in block ST1660 (97 in FIG. 9). Even if it is evident that user is interested in a product (weighting point of user preference is high), recommending an already watched or purchased product further to that user is meaningless in business viewpoint (advertisement effect cannot be expected). Then, a DVD (CD) which a given user has already watched or purchased apparently based on information of the watch/purchase history registered in the library is kept from being recommended to that user (block ST1662 of FIG. 17).

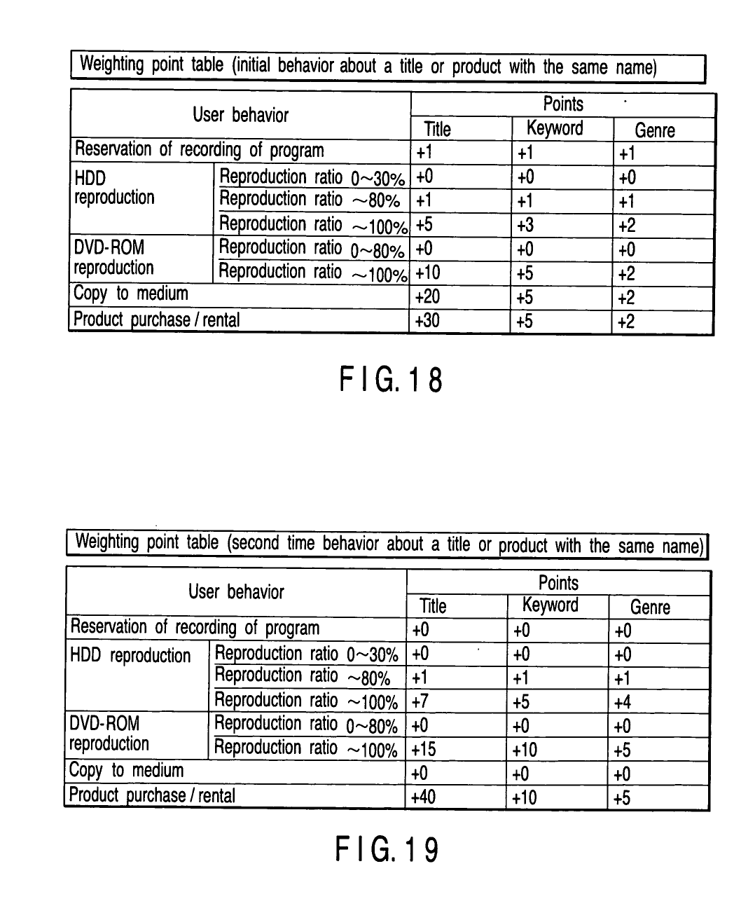

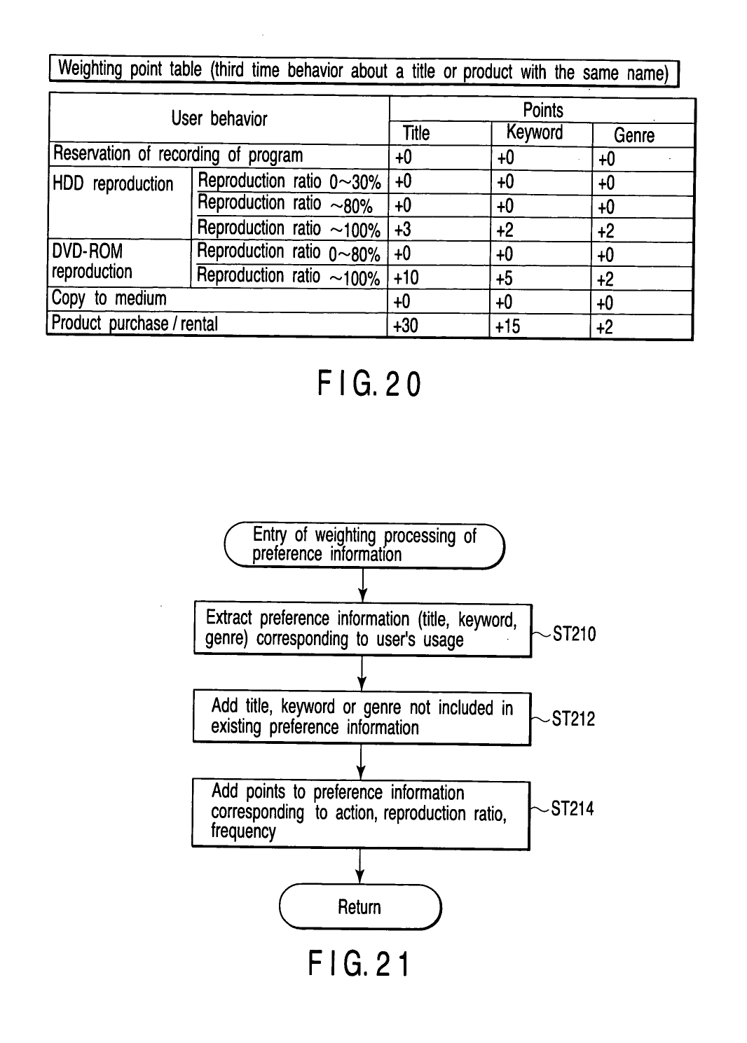

FIG. 18 shows an example of a weighting point table (time when user acts initially) to a same name title or same name product (product) and FIG. 19 shows another example (time when user acts for the second time) of weighting point table to the same name tile or same name product (product) and FIG. 20 shows still another example (time when user acts for the third time) of the weighting point table to the same name title or same name product (product). FIG. 21 is a flow chart for explaining a specific example of the weighting processing of preference information. How the preference information of individual user is weighted using FIG. 21 will be described with reference to FIGS. 18-20.

As a specific example of user behavior on the DVD video recorder having the structure shown in FIG. 1, whether or not recording of a program is reserved, reproduction ratio of a program recorded in HDD, reproduction ratio of distributed (marketed) DVD-ROM (DVD video disc), whether or not a copy is made to a medium (DVD-R and the like) (on a premise that there is no copyright infringement), whether or not a product is purchased (purchase of DVD or CD by mail order) and/or rental contract is made (application for rental DVD or rental CD) are assumed. The behavior of individual user is evaluated with a number of points corresponding to its behavior content in terms of its title (for example, MHK music show), keyword (for example, Hikari MISORA), genre (for example, Japanese ENKA song).

Speaking of the processing of FIG. 21, the firmware for executing the server side processing 97 of FIG. 9 extracts the preference information (title, keyword, genre and the like) of that user from database of the processing 100 of FIG. 9 corresponding to the behavior of the user (see FIG. 18) (block ST210). If the behavior of user concerns a title, keyword and/or genre not existing in the extracted preference information, the title, keyword and/or genre corresponding to that user behavior are added to the preference information of FIGS. 10-12 (block ST212). If the preference information of FIGS. 10-12 does not include a keyword “Photo album MISORRA HIKARI” although it includes a genre of “Japanese ENKA song” and a keyword of “Hikari MISORA”, the keyword of “Photo album Hikari MISORA” is added.

After addition of a title, keyword and/or genre corresponding to the behavior of user is completed, points are added to the preference information corresponding to an operation accompanied by that user (for example, reproduction of a program tile recorded in HDD), reproduction ratio (for example, reproducing 90% of entire program title), or frequency (block ST214). This addition of points changes as the user behavior progresses. For example, a weighting point table inherent of user, which has points as shown in FIG. 18 changes to FIG. 19 when the user acts for the second time and then to FIG. 20 when the user acts for the third time. In the meantime, the weight of FIG. 10 or 11 and/or the degree of importance of FIG. 13 can be raised corresponding to rise of points by the addition of points.

The frequency of reproduction as exemplified in FIG. 13 may be included in the column of user behavior although not described in the examples of FIGS. 18-20. In this case, it can be so constructed that the points of reproduction ratio increases as the frequency of reproduction increases. For example, in reproduction of HDD, it can be so constructed that while a title in which the reproduction frequency of 100% reproduction is first time is supplied with addition point of +5 points, a title in which the reproduction frequency of 100% reproduction is second time is supplied with +8 points and a title in which the reproduction frequency of 100% reproduction is three time or more is supplied with +10 points.

A title, in which the reproduction frequency turns to the second time by 100% reproduction at a second time (because user gets interested again although he watches it a little before) although the reproduction frequency of the title which is reproduced only less than 30% at the first time is zero in terms of addition points, may be supplied with +6 points which is higher than a case where the 100% reproduction is carried out once.

The purchase product name information list (FIG. 13) and the preference information 3 (FIG. 12) may be generated/held by the server side (FIGS. 8, 9). Further, the preference information may be generated/held by the server side while the client apparatus (FIGS. 8, 9) is used for sending the tile or keyword to the server.

In extraction of the keyword from description of a program, main words may be extracted using morphologic analysis. Although a variety of methods for weighting from the frequency of the keyword can be considered, the embodiment of the invention is not restricted to any particular weighting method.

In one embodiment, a video apparatus (video recorder, digital TV and the like) which presents or encourages to purchase a product or recommends a program by obtaining user preference information or information about whether or not user has watched or possessed as follows:

1. Obtains the keyword, weight and content title from one or more of the following means:
by reservation of broadcasting, reproduction or copying to DVD; (content information (title, description, performers and the like) can be obtained from Internet or broadcasting wave);
by reproduction of package CD or copying; (content information (album name, music title, artist name and the like) can be acquired from CDDB of Internet);
by reproduction of package DVD; (content information (title, content, performers and the like) can be acquired from CDDB of Internet);
by purchase of product (book, etc.); (information such as person name, genre, product name can be distinguished from purchased product); or
by rental; (information about genre, product name and the like can be distinguished from a rented object).

2. Weights the keyword using following information:
reproduction ratio at that time (whether reproduced from the beginning to the end or whether only a first portion is reproduced); or
reproduction frequency (whether only once or many times).

3. Obtains possessed content titles from means such as library information.

4. Sends the above-mentioned information (keyword and weight and title) to server in real time or regularly or irregularly, the server presents product information (recommendation, advertisement) optimum for user, and user's client apparatus indicates it. Information from purchase of products or rental is stored in the server and thus it does not need to be sent from the client side to the server.

5. Does not provide any product already possessed (purchased) or a product already known (watched).

6. May generate a keyword, weight and title by sending information which can specify a content such as program and music (broadcasting channel, broadcasting time, CD ID/music title ID and the like) to the server.

7. Enables a procedure for purchase by presentation of the information.

8. Recommends a program optimum for user by using the above-described information.

9. Does not recommend a program already watched or recorded.

In one embodiment, one or more features address a problem that even a program (movie and the like) already watched through DVD or the like is recommended can be met by not picking up an already watched program as a recommendation object by obtaining already watched content titles from information of following items:
Watching, reproduction and reservation of broadcasting or copying to DVD;
content information such as title, description, performers and the like can be obtained from Internet or broadcasting;
reproduction of package DVD;
content information such as title, content, performers and the like can be obtained from CDDB of Internet; or
library information.

In yet another embodiment, one or more features address: a problem that high accuracy preference information cannot be obtained if the preference information is obtained from only watching and its related operation can be met by using information of following items as well as the above-mentioned items:
Reproduction and copying of package CD;
content information such as album name, music title, artist name and the like can be obtained from CDDB of Internet;
Person's name, genre, product name and the like upon purchase of product (book, etc.);
Person's name, genre, product name and the like upon rental;
reproduction ratio at that time such as whether reproduced from beginning to end, only beginning is reproduced and the like; and
reproduction frequency (only once or many times)

In another embodiment, one or more features address: a problem that regarding the preference information, any information is not provided to a third party and that information is not returned to user can be met by presenting product information (recommendation, advertisement) optimum for user from the third party or displaying a purchase procedure screen by using information of the above-mentioned items.

A program and product information meeting user's preference and necessity and advertisement can be provided by usual device operation without forcing user to input any retrieval keyword by extracting the preference keyword and weight from information about program reservation/reproduction, reproduction of DVD/CD, sale/rental.

As a consequence, the accuracy of user's preference information can be raised, the program and product can be recommended accurately and an advertisement which user may be interested in can be presented. Then, user can acquire a desired information securely from an enormous amount of information and effective sale/advertisement activities are made possible for product retailers and advertiser.

Since the user preference can be detected based on detailed individual activities (recording of program, watching of program, software reproduction/recording, purchase of product/application for rental and the like) of each user, whereby likely intensifying the accuracy of the user preference information.

In the meantime, the invention is not restricted to the above-described embodiments but may be modified in various ways within a range not departing from the spirit of the invention based on available technology currently or in the future. The respective embodiments may be combined appropriately if possible and in that case, an effect of the combination can be obtained. The above-described embodiments include various aspects of the invention so that various further aspects can be extracted depending on appropriate combination of the disclosed plural components. For example, even if some components are erased from all the components disclosed in the embodiments, a configuration deprived of those components can be extracted as another aspect of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method comprising:
electronically receiving metadata associated with electronic content wherein the electronic content is stored in a transportable recording medium;
displaying at least a portion of the metadata as part of electronic guide information; and
determining a user preference based at least in part on the metadata.

2. The method according to claim 1 wherein the electronic content is stored on at least one selected from the group consisting of non-volatile memory, a DVD, a CD, and a hard drive.

3. The method according to claim 1 wherein the metadata comprises at least one of the group consisting of a title, a genre, a product name, and a user's name.

4. The method according to claim 1 wherein the metadata is obtained from a database.

5. The method according to claim 1 further comprising determining the user preference based at least in part on at least one selected from the group consisting of usage of the electronic guide information, recording of the electronic content, reproduction of the electronic content, recording of the electronic content in an information recording medium, purchasing the electronic content through display of the electronic guide information, and application for rental of the electronic content through the display of the electronic guide information.

6. The method according to claim 1, wherein weighting of the user preference is determined based on at least one selected from the group consisting of weighting corresponding to a reproduction ratio relative to the entire electronic content, weighting corresponding to reproduction frequency of the electronic content, weighting corresponding to reproduction number of the electronic content, and weighting depending on whether or not the electronic content is recorded in an information recording medium.

7. The method according to claim 2, comprising:
sending information of the user preference containing at least one selected from the group of the keyword, the weighting, and the content title, in a manner that is based on at least one selected from the group consisting of real time, regularly, and irregularly;
receiving information about a product based on the user preference; and
displaying to the user or notifying the user of the information about the product.

8. The method according to claim 7, wherein a product purchased through the display of the electronic guide information or a product requested for rental is registered as library information and information of a product whose registration history of being already purchased or already rented is contained in the library information is excluded from the product information.

9. The method according to claim 8, wherein an already recorded or watched product is excluded from a list of products identified based on the user preference.

10. An apparatus comprising:
processor circuitry that is configured to receive metadata associated with electronic content wherein the electronic content is stored in a transportable recording medium; and
processor circuitry for determining a user preference based at least in part on the metadata.

11. The apparatus according to claim 10 further comprising processor circuitry in a user device that is configured to display electronic guide information.

12. The apparatus according to claim 11 further comprising processor circuitry configured to record a program corresponding to the electronic guide information.

13. The apparatus according to claim 10 further comprising processor circuitry configured to determine the user preference based at least in part of one selected from the group consisting of usage of electronic guide information, recording of the electronic content, reproduction of the electronic content, recording of the electronic content in an information recording medium, purchasing the electronic content through display of the electronic guide information, and application for rental of the electronic content through the display of the electronic guide information.

14. A television receiving apparatus comprising:
at least one tuner that is configured to receive broadcast signals;
processor circuitry configured to transmit metadata associated with electronic content that is stored in a transportable recording medium to a server through a network;
processor circuitry configured to receive content information based at least in part on the metadata through the network; and
processor circuitry configured to display at least a portion of the content information as part of electronic guide information.

15. The apparatus according to claim 14 further comprising processor circuitry configured to record a program corresponding to the electronic guide information.

16. The apparatus according to claim 14 wherein the electronic content is stored on at least one selected from the group consisting of non-volatile memory, a DVD, a CD, and a hard drive.

17. The apparatus according to claim 14 wherein the metadata comprises at least one of the group consisting of a title, a genre, a product name, and a user's name.

18. The apparatus according to claim 14 wherein the metadata is obtained from a database.

19. The apparatus according to claim 14 wherein the metadata is periodically transmitted to the server.
